(19) United States
(12) Patent Application Publication
(10) Pub. No.: US 2013/0215402 A1
(43) Pub. Date: Aug. 22, 2013

(54) MODULAR PROJECTOR

(71) Applicants: Rob Sugarman, Huntington Station, NY (US); Elijah Stawicki, Huntington Station, NY (US)

(72) Inventors: Rob Sugarman, Huntington Station, NY (US); Elijah Stawicki, Huntington Station, NY (US)

(21) Appl. No.: 13/754,725

(22) Filed: Jan. 30, 2013

Related U.S. Application Data
(60) Provisional application No. 61/592,330, filed on Jan. 30, 2012.

(51) Int. Cl. G03B 21/14

(52) U.S. Cl. CPC G03B 21/145
USPC 353/119; 29/428

(57) ABSTRACT

An improved modular projector assembly is provided including at least an attachment mechanism to allow the image projector to be attached to a surface closely associated with the projector screen. The modular assembly further including at least a control unit that may be connected to the image projector. The control unit may enclose the supporting hardware and software of the projector assembly and may include ports, connectors, or other interface features. The projector assembly may further include a connectivity panel associated with the control unit. The connectivity panel may provide connections and interface controls for the projection assembly.

### PRIORITY CLAIM

This present application claims priority to the earlier filed U.S. Provisional Patent Application No. 61/592,330 filed on Jan. 30, 2012.

### FIELD OF THE INVENTION

The present invention relates generally to the field of a projector system. More specifically, the present invention relates to an apparatus and system for providing a complete projector apparatus and system in communication with digital media.

### BACKGROUND OF THE INVENTION

Projectors have been used in educational environments for some time. These projectors and optical presentation devices are used in a wide variety of industries and in various settings and applications. For example, the projectors and optical presentation devices may be utilized in classrooms for teaching applications, conference rooms for business presentations and in a plurality of other learning and training facilities to be utilized to visualize a learning concept. Due to the relatively high cost of such devices, financial loss due to damage and theft to these devices tends to be a problem to companies, institutions and agencies that purchase and utilize these projectors and optical presentation devices. Therefore, these projectors and optical presentation devices are generally at least semi-permanent, in that they are mounted in a room and used with a projector screen also fixed in the room. However, because the projector is semi-permanent and left in the room even after use, these devices are subject to theft by individuals using the room afterword, and/or may be subject to damage by other occupants of the room. Often times, students, employees or other individuals may use a room that houses the projectors and may damage them either intentionally or inadvertently. The cost associated with fixing and/or replacing these units may be prohibitive and may cause some institutions to only use the projectors where absolutely necessary.

Traditional presentation or audio-visual (AV) carts accommodate LCD projectors and various digital presentation devices but lack a security system to protect the devices from theft. In order to reduce losses from theft, various security solutions are available from manufacturers of security products. Although some of the security solutions may have a primary objective of theft protection, they possess certain deficiencies which fail to protect against theft but still allowing for mobility of the presentation devices. Furthermore, many security solutions are unable to secure a variety of different types of presentation devices. In addition, many security solutions require permanent attachment of the presentation devices to a plate or other object in order to prevent damage to the projector unit or optical presentation devices.

Moreover, the security systems in place to help prevent damage and theft to projectors and optical presentation devices are inefficient for other reasons. For example, most conventional security devices are made to house the projector and are typically affixed to a structure within the room housing the projector unit. While they allow for protection of the projector unit, they also require removal and/or substantial dismantling in order to replace or repair the unit if something were to be functionally wrong with the projector. Another problem with these type of projector units and the security devices associated with these projectors is that they lack portability of the projector and/or optical presentation device from one location to another. Therefore, if the room configuration changes or class size increases, the entire projector assembly or the presentation device must be completely detached from its housing, and/or position in the room, and must be completely re-wired for another room. This would be overly cumbersome and extremely labor intensive. The movement of the projector from one room to another would also require moving the protective housing and wiring structure in one room and relocating the entire assembly to another room.

Moreover, even utilizing an AV cart may not be the best solution. AV carts, while allowing movement of the projector from one room to another, still require significant wiring to be performed once the cart has been moved from one location to another. Often times, the wiring systems in place in the room will require the AV cart to be placed in a very specific place within the room, such as a location having electrical power and wiring access to project an image onto a mounted or affixed board within the room. Another problem associated with these AV carts is that they have to be placed in a specific location within the room to project onto the board that is usually fixed in place. However, because the AV cart is usually rolled and moved often, and because of its location within the room, the potential for accidental bumping of the cart along with the projector associated therewith greatly increases. Further, the ability to restrict and diminish the possibility of damage to the projector unit is not decreased in any way. On the contrary, because of its location and accessibility to more individuals within the room, the likelihood of damage to the projectors is in fact increased.

Another problem with most of the prior art projector systems is the inability to adjust the presentation angles, depth and distance from the screen on which the optical information is displayed. For example, in many prior art projector applications, the distance from the projector screen is fixed and the projector must be aligned both vertically and horizontally on the screen to fit the space. In essence, the projector must be in the exact location of the screen to be viewable by an audience. And because most projectors are not able to be adjusted outside a specific vertical and horizontal maximum, the adjustment of the projectors sometimes just looks awkward, no matter how much adjustment is made to the projector and/or screen. Therefore, by having the projector affixed to a structure when installed in the room is the best way to avoid having to adjust the picture and the vertical and horizontal orientation of either or both the projector and/or the screen.

### SUMMARY OF THE INVENTION

Embodiments as presented herein provide a projector mount that secures a projector or other digital presentation device to a support in an effective manner. In one embodiment, the disclosed mount can effectively secure a projector or other digital presentation device to a support and which further provides the capability of allowing removal and relocation of the projector assembly from one location to another. In another embodiment, an improved projector assembly is provided that may be mounted to a screen assembly and may be connected to hardware that allows for a third party device to be plugged into the projector assembly without having to continually adjust the optical presentation device.

The present invention provides an improved modular projector assembly including at least a attachment mechanism to allow the projector to be attached to a surface closely associated with the projector screen. The modular assembly further including at least a control unit that may be connected to the projector. The control unit also has a USB in port from a legacy device that may be connected to the control unit. It is contemplated that the control unit may be affixed to the back side of the projector screen thereby being out of view of an audience. Moreover, the projector assembly further includes a connectivity panel associated with the control unit. The connectivity panel may have a USB extender associated therewith to allow for connectivity to another computing and/or display device.

To this end, in an exemplary embodiment of the present invention, an apparatus and a system is provided for a modular projector and/or optical presentation device that may be portable and compact in design.

In an exemplary embodiment the present invention, a modular projector assembly, the assembly comprising: a first enclosure containing an image generator; a second enclosure separate from the first enclosure containing electronics to control the projector assembly; and an interface comprising at least one connector port and one user input.

In another exemplary embodiment, wherein the interface comprises a third enclosure separate from the first and second enclosures.

In another exemplary embodiment, wherein the second enclosure houses a light source.

In another exemplary embodiment, wherein a liquid light guide couples the first enclosure to the second enclosure such that light from the light source is projected through the image generator.

In another exemplary embodiment, wherein the first enclosure contains a light source.

In another exemplary embodiment, further comprises a light source coupled to the first enclosure.

In another exemplary embodiment, wherein the first enclosure comprises a second user input.

In another exemplary embodiment, wherein the second user input controls a focus of a projected image.

In another exemplary embodiment, wherein the interface comprises two or more ports of different configuration for accepting audio and video signals from an input device.

In another exemplary embodiment, wherein the interface comprises at least one port for connecting the modular projector assembly to a network.

In an exemplary embodiment the present invention, a modular projector assembly, comprising: an image projection device comprising a head enclosing an image generator, an arm, and a connection interface; a control unit coupled to the image projection device by a connectivity cable; and a connectivity plate coupled to the control unit by a connectivity cable, the connectivity plate enclosed in a housing separate from the image generator.

In another exemplary embodiment, wherein the head of the image projection device is variably positionable relative to the connection interface.

In another exemplary embodiment, wherein the image projection device creates an image from the modular projection assembly by transmitting light from a light source through the image generator, wherein the light source is outside an enclosure of the image generator.

In another exemplary embodiment, wherein the light source is within the control unit.

In another exemplary embodiment, wherein the connectivity plate is enclosed in the housing separate from a second housing of the control unit.

In another exemplary embodiment, wherein the connectivity plate comprises at least two ports of different protocols for receiving audio and video signals from a coupled device.

In another exemplary embodiment, wherein the connectivity plate comprises an interface for controlling at least one feature of the modular projector.

In another exemplary embodiment, wherein the head of the image projection device is removably connectable to the arm.

In another exemplary embodiment, wherein the control unit comprises electronics for support the modular projector's operation, a light source, a power supply, and a USB extender.

In an exemplary embodiment the present invention, a method of installing a modular projector, comprising: mounting an image projection device comprising a head enclosing an image generator and an arm to a support surface; orienting the head to create an image on a projection screen by manipulating the arm; manipulating the image through controls on the image projection device; coupling the image projection device to a separately enclosed control unit comprising the supporting electronics for the image projection device; coupling the image projection device to a separately enclosed connectivity plate; and manipulating the modular projector through an interface of the connectivity plate.

In another exemplary embodiment, an apparatus and system is provided for a modular digital projector assembly whereby the projector assembly has at least a light source.

Another exemplary embodiment is an apparatus and a system for providing a modular digital projector assembly whereby the projector assembly has at least a light source whereby the light source may be mounted to the end of a flexible arm allowing the installer/user to easily align the image on the projector screen.

Yet another exemplary embodiment of the present invention is to provide a modular digital projector assembly whereby the projector assembly has at least a light source whereby the light source has a housing assembly available in a round, square, rectangular, and triangular configuration.

Still another exemplary embodiment of the present invention is to provide a modular digital projector assembly whereby the projector assembly has at least a light source whereby the light source has multiple mounting options, including at least a clamp for mounting to the top of projector screen, a bracket that can be attached with adhesive to the back of projection screen and/or a wall/ceiling mount.

An exemplary embodiment of the present invention is to provide a modular digital projector assembly whereby the projector assembly has at least a light source whereby the light source is connected to the control unit with a single cable.

Yet another exemplary embodiment of the present invention is to provide a modular digital projector assembly whereby the projector assembly has at least a control unit that may be mounted to the back of a projection screen.

Another exemplary embodiment of the present invention is to provide a modular digital projector assembly whereby the projector assembly has at least a control unit whereby the control unit modular system may have a plurality of components including but not limited to a main circuit board, a lamp ballast, a main power unit and a USB extender (for third party device connectivity to computer).

Still another exemplary embodiment of the present invention is to provide a modular digital projector assembly whereby the projector assembly has at least a control unit whereby the control unit modular system may have a power cable for the projector that may be available in different lengths of adjustability to allow for the projector to be located is a standard power cord, available in a plurality of different lengths.

Yet another exemplary embodiment of the present invention is to provide a modular digital projector assembly whereby the projector assembly has at least a control unit whereby the control unit has a USB port for connectivity to pass through and activate the extension for third party products, including the projector screen.

In an exemplary embodiment of the present invention, a modular digital projector assembly is provided whereby the projector assembly has at least a control unit whereby the control unit connects to the connectivity plate with a single cable available in a plurality of different lengths.

Moreover, in another exemplary embodiment, a modular digital projector assembly is provided whereby the projector assembly has at least a connectivity plate associated with the projector assembly.

In yet another exemplary embodiment of the present invention, a modular digital projector assembly is provided whereby the projector assembly has at least a connectivity plate associated therewith, whereby the connectivity plate has a power source, source select, and volume controls along with AV-in connectivity for Composite, RGB (×2), HDMI (×2), Network, USB and RS232.

Still another exemplary embodiment of the present invention is to provide a modular digital projector assembly whereby the projector assembly has at least a connectivity plate associated therewith, whereby the connectivity plate may be available in a number of configurations depending on connectivity needs, including an active USB extension for pass through of third party USB devices including Interactive white boards, and projector screens.

An exemplary embodiment of the present invention is to provide a modular digital projector assembly whereby the projector assembly has at least a connectivity plate associated therewith, whereby the connectivity plate may at least be connected to the control unit via a single connectivity cable. Further, it is contemplated that the connectivity plate is associate with, but not affixed to the control unit, thereby allowing for remote location of the connectivity plate corresponding to the control unit.

Still another exemplary embodiment of the present invention is to provide a modular digital projector assembly whereby the projector assembly has at least a connectivity plate associated therewith, whereby the light source unit may be a projector and further wherein the projector may be placed in connection to the screen apparatus or interactive white board assembly.

Yet another exemplary embodiment of the present invention is to provide a modular digital projector assembly whereby the projector assembly has at least a light source unit which is connected to a control unit, said control unit connected to a connectivity panel.

Another exemplary embodiment of the present invention is to provide a modular digital projector assembly whereby the projector assembly has at least a lighting source which projects light onto a projector screen and/or interactive white board and further whereby the light source is clamped onto the projector screen and/or interactive white board.

Still another exemplary embodiment of the present invention is to provide a modular digital projector assembly whereby the projector assembly has at least a lighting source which projects light onto a projector screen and/or interactive white board and further whereby the light source is connected to a bracket assembly whereby the bracket assembly is affixed to the projector screen and/or interactive white board.

Yet another exemplary embodiment of the present invention is to provide a modular digital projector assembly whereby the projector assembly has at least a lighting source which projects light onto a projector screen and/or interactive white board and further whereby the light source is removably connected to a wall mount which may be located immediately below, above, or on the side of the projector screen and/or interactive white board.

Another exemplary embodiment of the present invention is to provide a modular digital projector assembly whereby the projector assembly has at least a lighting source which projects light onto a projector screen and/or interactive white board and further whereby the light source is removably attachable to any of the clamp, bracket or another attachment mechanism which may be located immediately on, or in close association with the projector screen and/or interactive white board.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWINGS

FIGS. 1A and 1C illustrate side views and FIG. 1B illustrates a back view of a projector screen including a modular projector apparatus and assembly according to an exemplary embodiment;

FIG. 2 illustrates a front view of a connectivity plate portion of the modular projector apparatus according to an exemplary embodiment;

FIGS. 3A and 3B illustrate side views of a control unit of the modular projector apparatus according to exemplary embodiments; and

FIGS. 4A and 4B illustrate a back side view of an image projection device of the modular projector apparatus according to exemplary embodiments and FIG. 4C illustrates a side view of an image projection device of the modular projector apparatus.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Embodiments of the present invention comprise a projection system that permits the image projection device, to be semi-permanently or permanently positioned with respect to a projector screen. The weight of the projection device is generally reduced to permit easy installation and mounting with respect to the screen. A control unit un-connectable and re-connectable to the image projection device may include the electronics, power, light source, and other necessary circuitry, controls, and software to support the projection system. The control unit may be in a separate housing from the image projection device and connectable through one or more cables. The projection system may also include a connectivity plate that provides a light weight, multi-functional input interface to the projection system. For example, the connectivity plate may include user input options, such as buttons, toggles, switches, etc. as well as electronic interfaces, such as ports, plugs, jacks, etc. The connectivity plate may be separately housed from either or both of the image projection device and the control unit for easy access and interface for the projection system.

As shown and described, the projection system comprises three or more separately housed devices, including the projection device, the control unit, and the connectivity plate, coupled together by one or more connectors and/or cables. Each housing contains select components of the projection system. However, the embodiments as described herein are illustrative only and are not so limited. Alternatively, each device may be reconfigured, subdivided, combined, or otherwise configured, while remaining within the scope of the invention. Accordingly, components found within one housing may be moved to another housing, or components within one housing may be subdivided into two or more further housings. Considerations for the two or more housing configuration may be determined by the individual need of the environment and desired use, including the mounting configuration, installation constraints, permanence and/or portability of one or more portions of the system, security, accessibility, integration with other systems and diversity of third party devices, etc. For example, for a two housing system, the connectivity plate may be integrated into the control unit. Alternatively, for a four housing system, the light source from either the image projection device or the control unit may be separated into its own housing, including necessary circuitry and support features, such as fans.

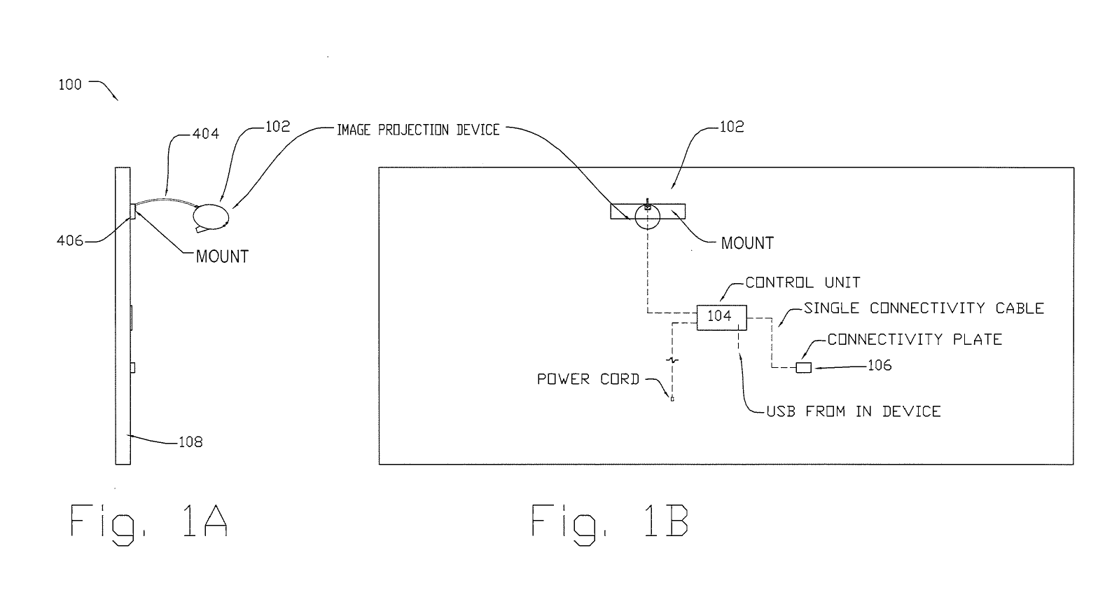

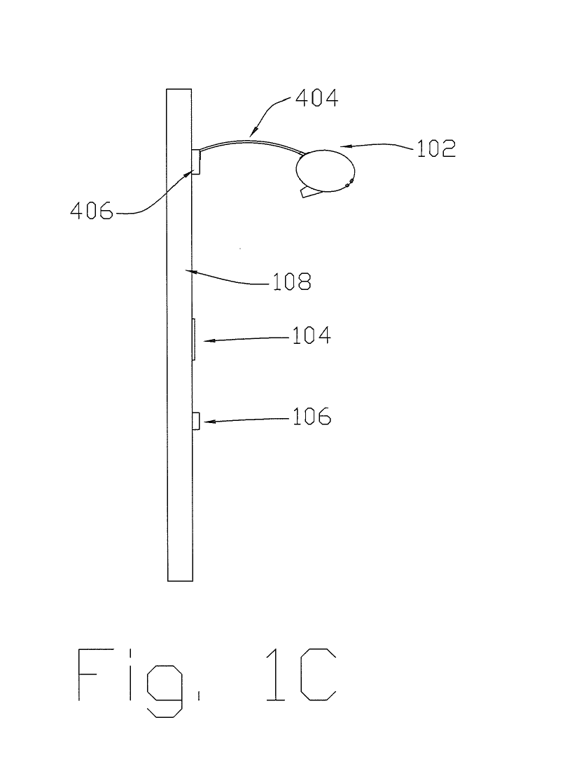

FIG. 1 illustrates an exemplary embodiment of the projection system 100 including an image projection device 102, control unit 104, and connectivity plate 106.

The image projection device 102 is generally mounted on or near a projection screen 108. As shown, the image projection device 102 is mounted to a wall 108. In addition to a wall, the image projection device may also be mounted to a ceiling or back of a projection screen. The image projection device 102 may then be configured to provide, either directly or indirectly an image to the front of the screen. The image projection device 102 is generally light weight to provide easier installation. The image projection device 102 may contain limited components such as the image generator either alone or with a light source. The limited components reduce the weight of the image projection device to reduce the weight and increase the versatility of mounting options, while reducing installation costs. The image projection device may be positioned out of the way for easy continued use. The mounting may be permanent or semi-permanent such that the image projection device may be retained in generally the same location. Therefore, the image projection device may set up with respect to the projection screen so that the image focus, size, and position may be configured during installation and not reconfigured at each individual use; thus reducing set-up time between individual uses. Although the image projection device may generally be in the open, the mounting position and permanence may be selected based on the security requirements of the environment. Even in the event of a security breach and a image projection system is removed from the location, replacement costs may be reduced as a complete projection system does not have to be reinstalled because of the modular design of the system.

The control unit 104 is directly or indirectly coupled to the image projection device 102 through one or more cables and/or connections. The control unit 104 may include the supporting electronics and components for the image projection device 102. The control unit 104 as illustrated in FIG. 1 is also positioned on a wall 108. However, the control unit 104 may be positioned as desired by the use of the system. For example, the control unit may be removed to a cabinet, wall mount, ceiling mount, on screen mount (either a front, rear, or side surface), enclosed or other secure position such as a lock-box or wall safe area. The control unit 104 containing the majority of the supporting electronics for the projection system may be permanently or semi-permanently located in a securely accessible location. Because the control unit does not include the image generation electronics, it may be located independent of the image projection device and the projection screen. Alternatively, the control unit 104 may be removably coupled to a static location, such that is may be easily removed and portably moved and attached to a separate image projection device at another location. Thus, the modular components may be interchangeable between system configurations.

The connectivity plate 106 may also be independently positioned with respect to either or both of the image projection device 102 and the control unit 104 and directly or indirectly coupled to the control unit through one or more cables and/or connections. The connectivity plate 106 may provide input controls to a user as well as interface connections to other devices, systems, or networks. As shown in FIG. 1, the connectivity plate is mounted to the wall 108. However, the connectivity plate may not be mounted elsewhere, such as a wall, console, screen, etc. Alternatively, the connectivity plate may not be mounted but generally positioned in proximity to a user to provide access to the input controls, interfaces, and connectors. The separate connectivity plate provides easy access to the projection system in a small, lightweight interface for easy mounting and/or maneuverability.

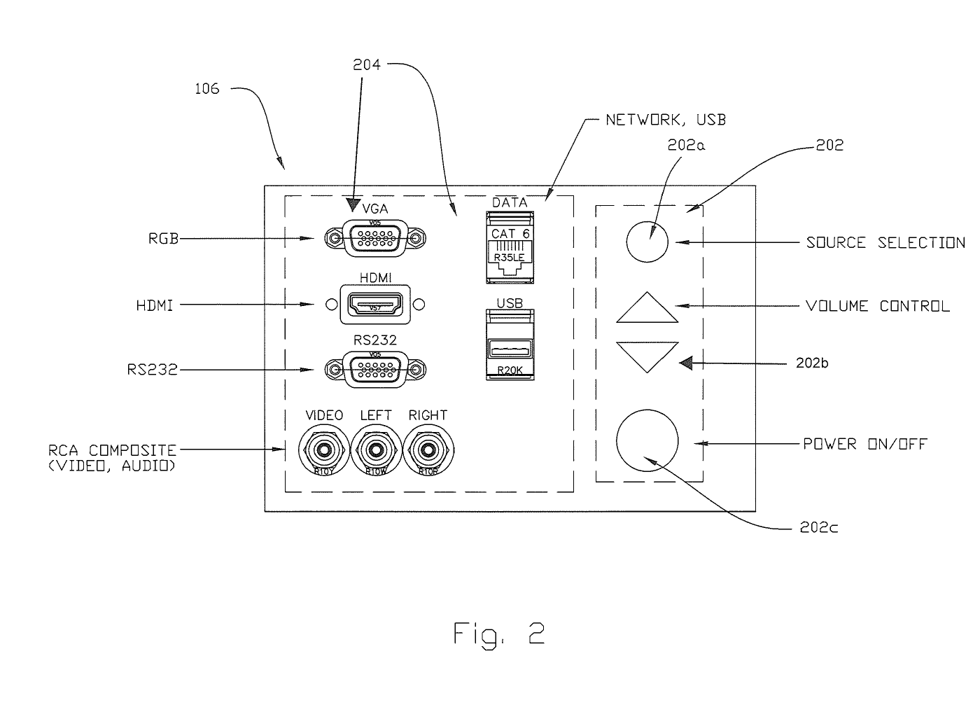

FIG. 2 illustrates an exemplary embodiment of the connectivity plate 106. The connectivity plate 106 may provide various connectors, input/output, and/or controls for the projection system 100. The connectivity plate may include user controls 202 as well as one or more connectors 204. The connectivity plate may include a variety of configurations depending on the connectivity needs, including active USB extension for pass-through of third party Universal Serial Bus (USB) devices including an interactive white board.

Exemplary connectors may include one or more audio, video, composite, network connections such as Red/Green/Blue (RGB) Video Graphics Adapter (VGA), High Definition Multimedia Interface (HDMI), serial ports, such as RS232, network ports, such as Cat 6, or USB, as well as composite video/audio ports, such as RCA composite video, left and right audio. The connectivity plate may provide removable and/or interchangeable ports to allow connection interfaces to be upgraded as new technologies are released without needing to replace the entire plate.

The connectivity plate is contained within a housing. The housing may be configured depending on the needs of the environment as well as the desired connection and control interface features. The housing and associated connectors and controls may be coupled to the control unit through one or more connectors. In an exemplary embodiment the connector plate may simply be a pass through from a connected device to the control unit allowing easy access to the projection system in a convenient, lightweight, easily manipulated and movable device. Alternatively, the connectivity plate may include hardware and software to convert any incoming signal, into a single signal protocol before forwarding onto the control unit. For example, regardless of the connected source, all A/V signally may be converted to HDMI before being transmitted to the control unit. The connectivity plate may include one or more integral or connectable cable between the connectivity plate and the control panel depending on what, if any, pre-processing is performed within the connectivity plate.

The connectivity plate may include user controls 202 such as a source selection 202a, volume 202b, and power 202c. The source selection 202a may be used to select which coupled device to project through one or more of the connectors 204. Other user controls may be present as desired by a user, such as focus, zoom, brightness, color, contrast, etc. The user controls may be in the form of buttons, toggles, keys, switches, pads, touch screen, or other input means. The user controls may be duplicated between one or more portions of the projection system.

The connectivity plate may also include a power cord or other power source. Alternatively, the connectivity plate may obtain power from the control panel through one or more connections between the connectivity plate and the control panel. If power is unnecessary, such as if the connectivity plate is simply a pass through to the control panel, the connectivity plate may not include a power source.

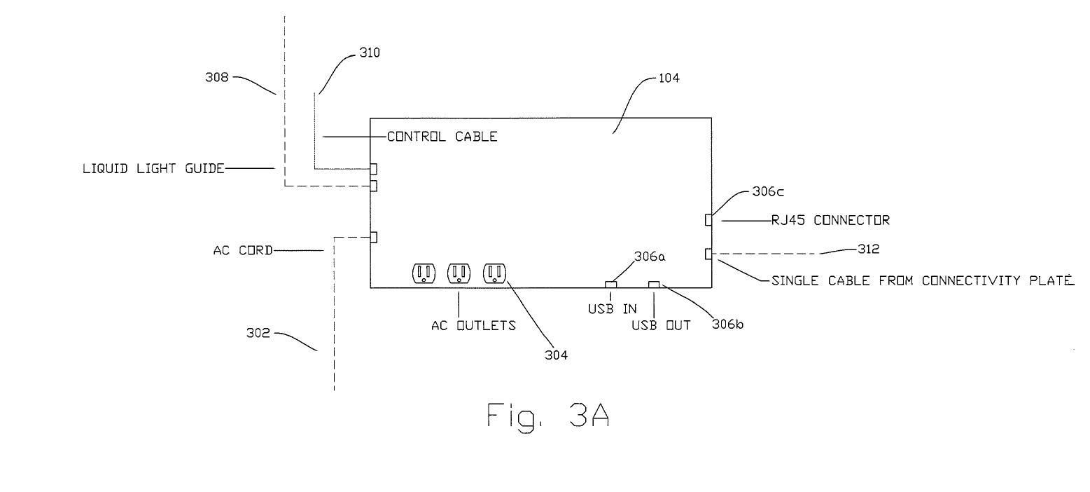

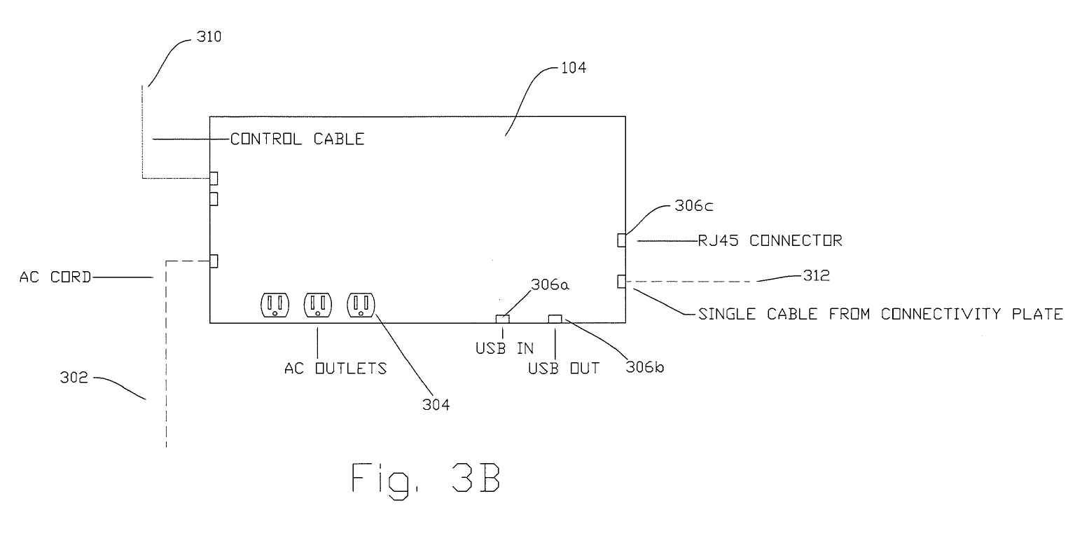

FIG. 3 illustrates an exemplary embodiment of a control unit 104. The control unit 104 may be mounted to a back of the projection screen, wall, ceiling, furniture, or other secure location. The control unit may include one or more connection ports, similar to the connectivity plate to provide additional connectivity of the device. The control unit 104 may also include user controls, similar to the connectivity plate. The redundancy of the ports and controls on the control unit with the connectivity plate increases versatility by providing additional sources of input and control to a user or permitting a user to bypass the connectivity plate and use the control unit directly.

In an exemplary embodiment, the control unit 104 is a modular system consisting of four major components that can be replaced independently in the field. The described components are exemplary and may be subdivided, combined, removed, or incorporated into other portions of the projection system 100. First, the control unit 104 may include electronics, as hardware or software, to control the projection system 100. For example, a main circuit board, including a processor, memory, and/or other electronic hardware supporting software may be included to handle the projection system's operations. Second, the control unit 104 may include a power system. For example, the control unit 104 may include the power supply of the projection system, and may include for example, a standard alternating current (AC) cord 302 and plug. The control unit 104 may include internal hardware to provide high voltage to external components through one or more outlets, connectors, or cables on the outside of the unit. For example, one or more outlets 304 may be present to provide power to other devices, such as connected computers, and/or other parts of the projection system. Third, the control unit 104 may include a connector extender, for third party device connectivity. In an exemplary embodiment, the control unit 104 include one or more connector ports. For example, USB in 306a and USB out 306b ports may be provided for third party connectivity such as to a computer. The USB ports 306a and 306b may be used for connectivity pass-through and active extension for third-party products, for example interactive white boards. Other additional or alternate connectors may also be included such as RJ 45 connector port 306c. The serial port may be used for networking the projector and/or network control of the projector. Finally, the control unit 104 may include a light source. The light source may be a lamp module which can be a traditional Ultra High Performance Lamp or Light Emitting Diode, or other known projection light source.

The control unit 104 may be coupled to the connectivity plate 106 by one or more cables. As shown, a single HDMI connection cable 312 is present when the connectivity plate converts the received single to a common protocol before forwarding onto the control unit. Alternatively, one or more connectors may be used to support different protocols coupled to the connectivity plate depending on the device connected. The control unit may then include hardware and/or software to convert the incoming signal into a desired usable format. Other connections may also be present, and does not necessarily include physical wiring. For example, wireless or other non-physical connection may be used between the control unit 104 and the connectivity plate 106.

One or more connectors may also be coupled between the control unit 104 and the image projection device 102. One connector may be used as a control cable 310, in which electrical signals, data information, or power are sent between the image projection device 102 and the control unit 104. In an exemplary embodiment, the image projection device 102 is connected to the control unit 104 with a single control cable. This cable may transmit power, control and image information to the image projection device, including the image generator.

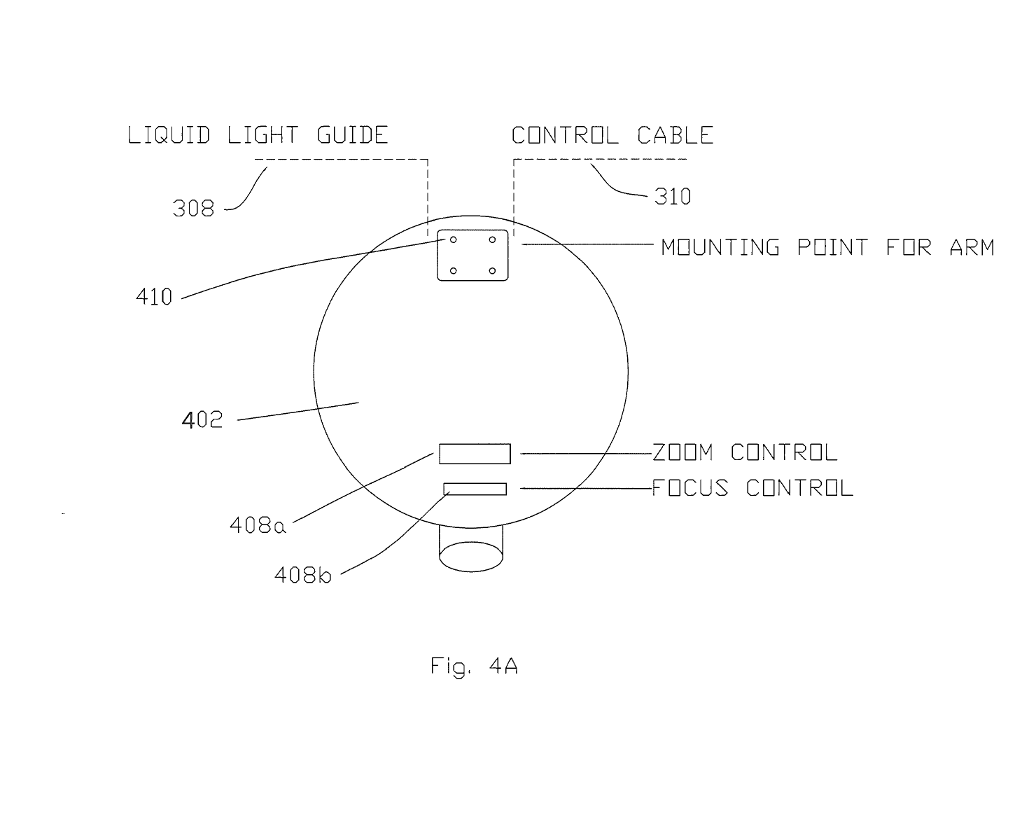

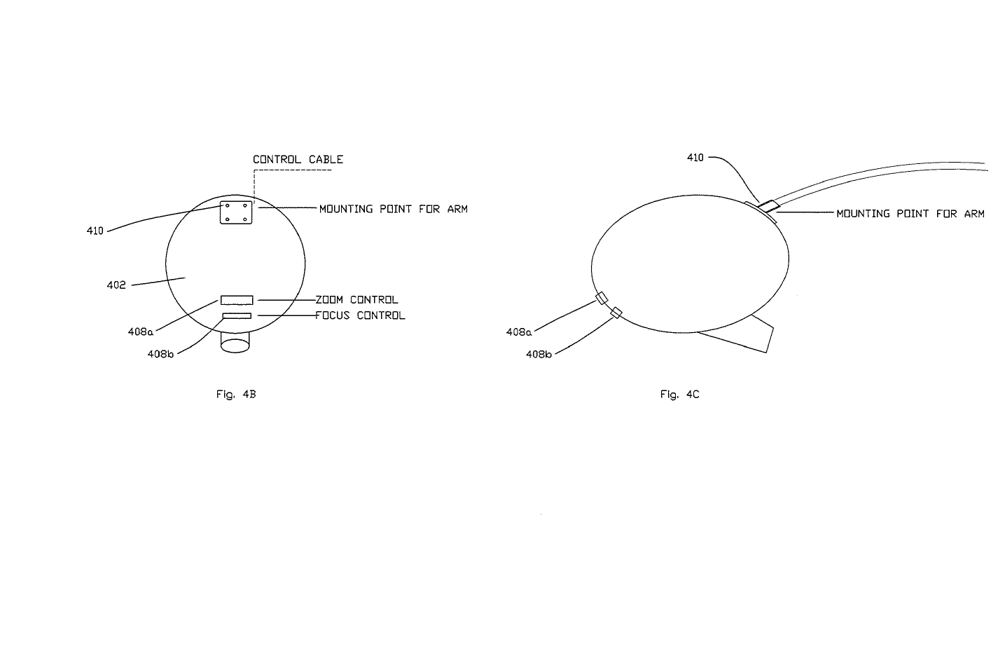

As shown in the combination of FIGS. 3A and 4A, the light source may be incorporated into the control unit 104, with the generated light sent to the image projection device 102. The light from the light source of the control unit 104 may be ported through light guide 308, such as for example a liquid light guide, and projected through the image generation hardware contained in the image projection device 102. The light guide may be coupled to the modular components of the projector system through any removable or permanent connection, such as for example a screw-on connector. Alternatively, as shown in the combination of FIGS. 3B and 4B, the light source may be included directly in the image projection device 102 along with the image generation hardware. Therefore, a light guide is not necessary between the control unit 104 and the image projection device 102.

In an alternative embodiment to using the light guide, the light source or light generation equipment may be housed in the control unit 104 and use laser light technology to port the light to the image projection device.

As seen in FIG. 4, exemplary embodiments of the image projection device 102 is partially shown. The image projection device 102 may include a head 402, arm 404, and mounting interface 406. The head may include the image generator, including the projector optics and the image generation technology, such for example 3DLP- or 3LCD-technologies and any other related circuitry. The head may also include the light source or may receive light from a light source within another portion of the projection system 100, including either the image projection mounting interface 406, or the control unit 104. A liquid light guide or other light conduit may be used to conduct the light from the light source to the image generator. The head 402, arm 404, and mounting interface 406 may be separable and interchangeable with other head, arm, and mounting interface configurations to provide additional versatility to the system. For example, different head portions may be provided depending on the size of the image required, such as for standard (4:3 aspect ratio) and widescreen (16:10/16:9 aspect ratio). The head and/or light source may therefore be easily upgraded or replaced by removing it from the mount and installing a new head portion. For example, in an exemplary embodiment the head portion may include a mounting bracket 410 to couple to the flexible arm.

The image projection device 102 may also include an arm 404 that may be positionable relative to the mounting interface 406 and the projection screen. In an exemplary embodiment, the arm is flexible to allow the installer and/or user to easily align the projected image onto a screen. The arm may be flexible along its length, or may be made of one or more jointed segments that provides variable positions of the head 402 relative to the mounting interface 406. The arm may also enclose one or more cables, for example the liquid light guide or the control cable. The enclosed cables may traverse or pass through the mounting plate or exit at an end or along the arm near the mounting interface 406. For example, an integral cable may be enclosed within the arm 404 between the head 402 and the mounting interface 406. The mounting interface may then include one or more connectors for coupling an associated cable to another portion of the projection system 100, such as to the control unit. Alternatively, a single integrated cable may run from the head 402 through the aim 404 and may be sufficiently long to connect directly to a port on the control unit, without requiring a separate extender.

The mounting interface 406 may be any connection system to removably, permanently, or semi-permanently position the head 402 with respect to a projection screen, and/or the mounting interface with respect to a mounting surface. For example, the mounting interface 406 may include a clamp mount, wall mount, or self adhesive mount to a mounting surface. The mounting interface 406 may be configured to correspond to a desired mounting surface, such as, for example, a wall, ceiling, or surface or side/edge of the projection screen. The arm 404 may be configured to properly position the head 402 relative to the projection screen depending on the mounting option chosen. For example, a mounting system for securing the head 402 to the back surface of the projection screen may include an extension to the arm 404, such that the head is positioned on a front side of the screen opposite the mounting interface. The extension arm may be selectively incorporated depending on the mounting options available at a given location. The mounting interface 406 may also include hardware and/or software for supporting the projection of an image.

The image projection device 104 may also include interface options, such as input control buttons 408a and 408b. The interface options may include control inputs that permit image manipulation during installation of the image projection device 104. In an exemplary embodiment, the image projection device 104 may be mounted through the mounting interface. During the mounting process, the image projection device, may be properly positioned by orienting the arm and the mounting interface as desired with respect to a mounting surface and a projection screen. The interface on the image projection device may then be used during installation to properly focus, zoom, or otherwise create a desired projected image onto the projection screen. These controls on the image projection device directly permits an installer to simultaneously configure the position and the image settings from one location. The control interface may be positioned on either the mounting interface, the arm, or the head. Control interface features may include, for example, zoom 408a or focus 408b, but may also include any combination of setting features for the projection system 100. These control features may be incorporated into other portions of the projection system to improve accessibility depending on the position of the user.

Embodiments, as described herein, provide a modular solution to projection systems. The modular components provide increased interchangeability, installation options, reduced installation costs, reduced replacement costs, reduced upgrade costs, and generally greater versatility. Embodiments as described herein are illustrative only. Each of the modular components, including the connectivity plate, control unit, and image projection device may be contained within separate housings. The housings may be configured according to the needs of the environment. Each housing may include one or more connector for coupling separate housings together. The connectors may removeably coupled to each house and/or permanently coupled or otherwise integrated into one or more of the individual housings. The features of one or more of the modular components may be duplicated or transferred from one component to another. Alternatively, the modular components may be subdivided, combined, or otherwise reconfigured to meet the requirements of the use and environment. Embodiments as described herein generally describe a projection system for use with a screen. The screen may include any surface for projecting an image, such as a wall, white board, chalk board, other board, retractable screen, etc.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed:

1. A modular projector assembly, the assembly comprising:
a first enclosure containing an image generator;
a second enclosure separate from the first enclosure containing electronics to control the projector assembly; and
an interface comprising at least one connector port and one user input.

2. The modular projector assembly of claim 1, wherein the interface comprises a third enclosure separate from the first and second enclosures.

3. The modular projector assembly of claim 2, wherein the second enclosure houses a light source.

4. The modular projector assembly of claim 3, wherein a liquid light guide couples the first enclosure to the second enclosure such that light from the light source is projected through the image generator.

5. The modular projector assembly of claim 2, wherein the first enclosure contains a light source.

6. The modular projector assembly of claim 2, further comprises a light source coupled to the first enclosure.

7. The modular projector assembly of claim 2, wherein the first enclosure comprises a second user input.

8. The modular projector assembly of claim 7, wherein the second user input controls a focus of a projected image.

9. The modular projector assembly of claim 2, wherein the interface comprises two or more ports of different configuration for accepting audio and video signals from an input device.

10. The modular projector assembly of claim 2, wherein the interface comprises at least one port for connecting the modular projector assembly to a network.

11. A modular projector assembly, comprising:
an image projection device comprising a head enclosing an image generator, an aim, and a connection interface;
a control unit coupled to the image projection device by a connectivity cable; and
a connectivity plate coupled to the control unit by a connectivity cable, the connectivity plate enclosed in a housing separate from the image generator.

12. The modular projector assembly of claim 11, wherein the head of the image projection device is variably positionable relative to the connection interface.

13. The modular projector assembly of claim 12, wherein the image projection device creates an image from the modular projection assembly by transmitting light from a light source through the image generator, wherein the light source is outside an enclosure of the image generator.

14. The modular projector assembly of claim 13, wherein the light source is within the control unit.

15. The modular projector of claim 13, wherein the connectivity plate is enclosed in the housing separate from a second housing of the control unit.

16. The modular projector of claim 15, wherein the connectivity plate comprises at least two ports of different protocols for receiving audio and video signals from a coupled device.

17. The modular projector of claim 16, wherein the connectivity plate comprises an interface for controlling at least one feature of the modular projector.

18. The modular projector of claim 11, wherein the head of the image projection device is removably connectable to the arm.

19. The modular projector of claim 11, wherein the control unit comprises electronics for support the modular projector's operation, a light source, a power supply, and a USB extender.

20. A method of installing a modular projector, comprising:
mounting an image projection device comprising a head enclosing an image generator and an arm to a support surface;
orienting the head to create an image on a projection screen by manipulating the arm;
manipulating the image through controls on the image projection device;
coupling the image projection device to a separately enclosed control unit comprising the supporting electronics for the image projection device;
coupling the image projection device to a separately enclosed connectivity plate; and
manipulating the modular projector through an interface of the connectivity plate.
